(19) United States
(12) Patent Application Publication
(10) Pub. No.: US 2005/0157091 A1
(43) Pub. Date: Jul. 21, 2005

(54) Method for fabricating an enlarged fluid chamber

(76) Inventors: Hung-Sheng Hu, Kaohsiung (TW); Wei-Lin Chen, Taipei (TW); Ming-Chung Peng, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/030,396

(22) Filed: Jan. 6, 2005

(30) Foreign Application Priority Data
Jan. 16, 2004 (TW) 93101152

(51) Int. Cl. B41J 2/05; B41J 2/17; B41J 2/04

(52) U.S. Cl. 347/65; 347/94

(57) ABSTRACT

A method for fabricating an enlarged fluid chamber using multiple sacrificial layers. The method comprises providing a plurality of patterned sacrificial layers between a substrate and a structural layer. A chamber neck is formed between a fluid chamber and a fluid channel using different sacrificial layers with different etching rates. The chamber neck can stabilize ejection of the fluid droplet. Additionally, a single print-head chip with different chamber sizes can also be formed, thereby ejecting droplets with different sizes.

### BACKGROUND OF THE INVENTION

1. Field of the Invention

The present invention relates to a method for manufacturing a fluid injector, and more particularly, to a method for fabricating an enlarged fluid chamber of a fluid injector using multiple sacrificial layers.

2. Description of the Related Art

Typically, fluid injectors are employed in inkjet printers, fuel injectors, biomedical chips and other devices. Among inkjet printers presently known and used, injection by thermally driven bubbles has been most successful due to its reliability, simplicity and relatively low cost.

FIG. 1 is a conventional monolithic fluid injector 1 as disclosed in U.S. Pat. No. 6,102,530, the entirety of which is hereby incorporated by reference. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to eject the fluid 26 from the chamber 14.

The conventional monolithic fluid injector using a bubble as a virtual valve is advantageous due to reliability, high performance, high nozzle density and low heat loss. However, when inkjet chambers are arranged in a tight array for a high device spatial resolution, they need to share one common liquid supply. As a result, the pressure generated from the firing chamber can affect the meniscus at the nozzles of its neighboring chambers, posing hydraulic crosstalk. Hydraulic crosstalk makes droplet volume control difficult and even causes unexpected droplet ejection when combined with thermal crosstalk.

U.S. Pat. No. 5,278,584, the entirety of which is hereby incorporated by reference, describes an ink flow path between an ink reservoir and vaporization chambers in an inkjet printhead. FIG. 2 is a partial view of a conventional fluid injector with a chamber neck 80 between a fluid chamber 72 and a fluid channel. In operation, fluid flows from the fluid reservoir (not shown) into the fluid chamber 72, as shown by the arrow 88. Upon energization of the thin film resistor 70, a thin layer of the adjacent ink is superheated, causing explosive vaporization and, consequently, causing a droplet of ink to be ejected through the nozzle 71. However, the chamber neck 80 between a chamber 72 and a fluid channel increases fluid impedance and slows down the refilling process and thus the period of an ejection cycle.

### SUMMARY OF THE INVENTION

An object of the present invention is to provide multiple steps of removing and etching multiple sacrificial layers to enlarge the fluid channel.

Another object of the present invention is to provide multiple steps of removing and etching multiple sacrificial layers to create a neck between a chamber and a fluid channel stabilizing the ejected fluid.

Another object of the present invention is to provide multiple steps of removing and etching the multiple sacrificial layers to form different size chambers, thereby ejecting droplets with different sizes and improving printing resolution.

Accordingly, the invention provides a method for fabricating an enlarged fluid channel. The method comprises providing a substrate, forming a patterned first sacrificial layer on the substrate, forming a patterned second sacrificial layer overlying the substrate and covering the first sacrificial layer, wherein the first sacrificial layer and the second layer are made of different materials, forming a patterned structural layer overlying the substrate covering the patterned second sacrificial layer, forming a fluid channel through the substrate and exposing the second sacrificial layer, removing the second sacrificial layer to form a chamber, and enlarging the chamber.

A fluid actuator, a driving circuit communicating with the fluid actuator and a passivation layer covering the fluid actuator and the driving circuit are formed on the structural layer.

The sacrificial layer comprises borophosphosilicate glass (BPSG), phosphosilicate glass (PSG), or silicon oxide. The structural layer comprises a low stress silicon oxynitride (SiON) or low stress silicon nitride (Si₃N₄).

The fluid channel is anisotropically etched using KOH, tetramethyl ammonium hydroxide (TMAH), or ethylene diamine pyrochatechol (EDP) solution. The second sacrificial layer is etched and removed by concentrated HF solution.

A nozzle is formed by etching the structural layer, thereby communicating the enlarged fluid chamber. The fluid is ejected from the nozzle.

The present invention improves on the related art in that a chamber neck is formed between a fluid chamber and a fluid channel using different sacrificial layers with different etching rates. The chamber neck can stabilize ejection of the fluid droplet. Additionally, a single print-head chip with different chamber sizes can also be formed, thereby ejecting droplets with different sizes and improving printing resolution.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view of a conventional monolithic fluid injector;

FIG. 2 is a broken view of a conventional fluid injector with an ink flow path between an ink reservoir and fluid chambers;

FIGS. 3A-3E are schematic views of a method for manufacturing an enlarged fluid chamber using multiple sacrificial layers according to a first embodiment of the present invention;

FIGS. 4A-4E are schematic views of a method for manufacturing an enlarged fluid chamber using multiple sacrificial layers according to a second embodiment of the present invention; and

FIGS. 5A-5E are schematic views of a method for manufacturing an enlarged fluid chamber using multiple sacrificial layers according to a third embodiment of the present invention.

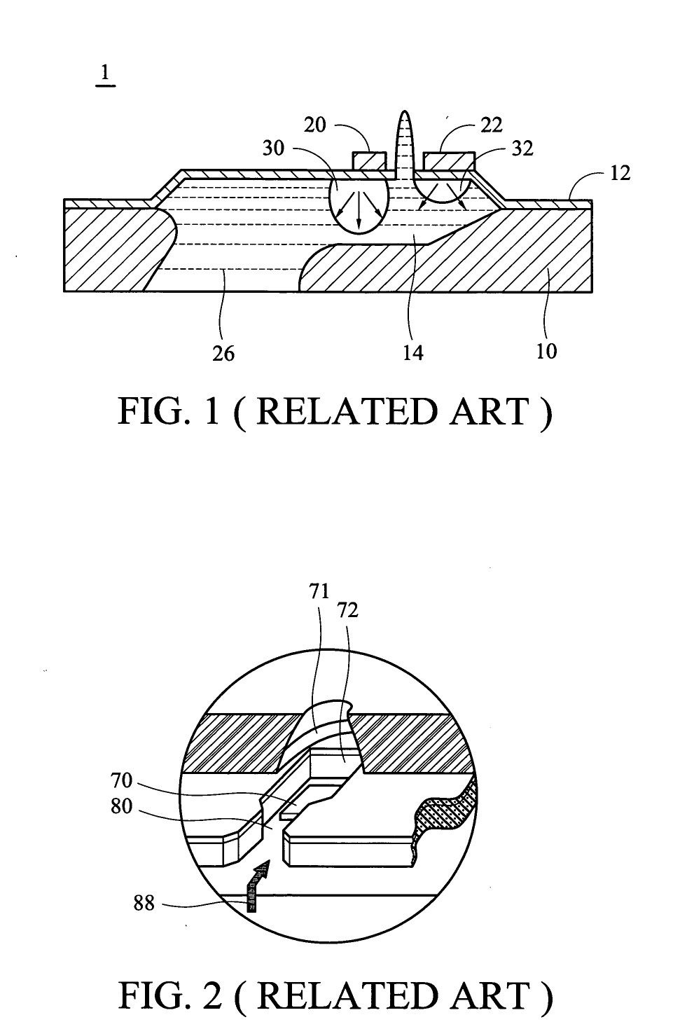

### DETAILED DESCRIPTION OF THE INVENTION

First Embodiment

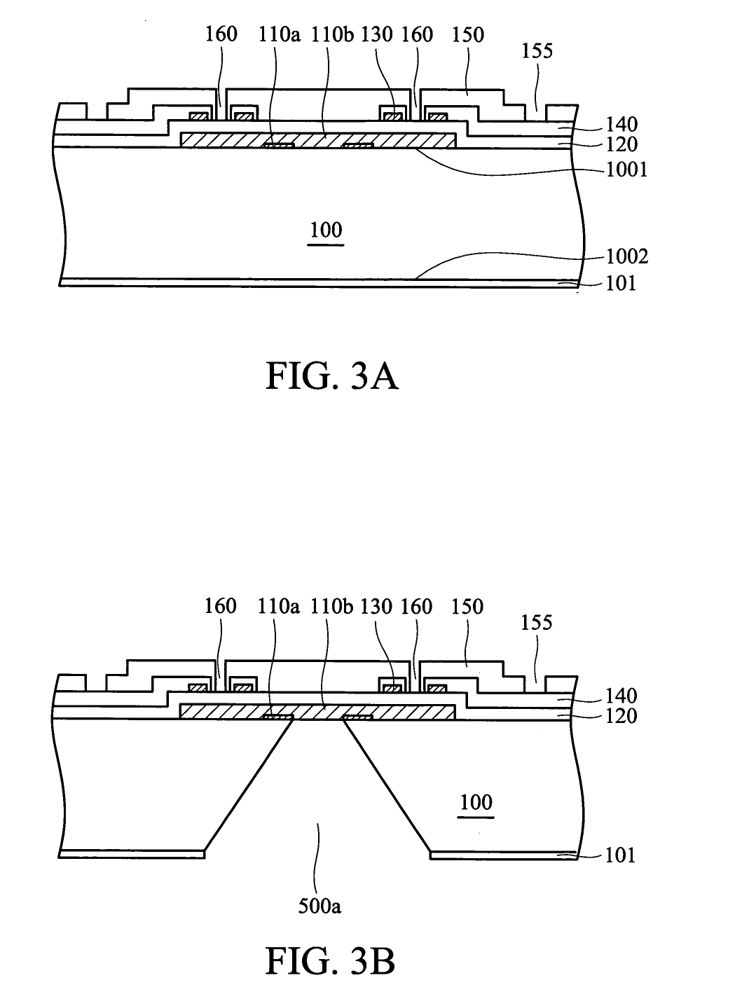

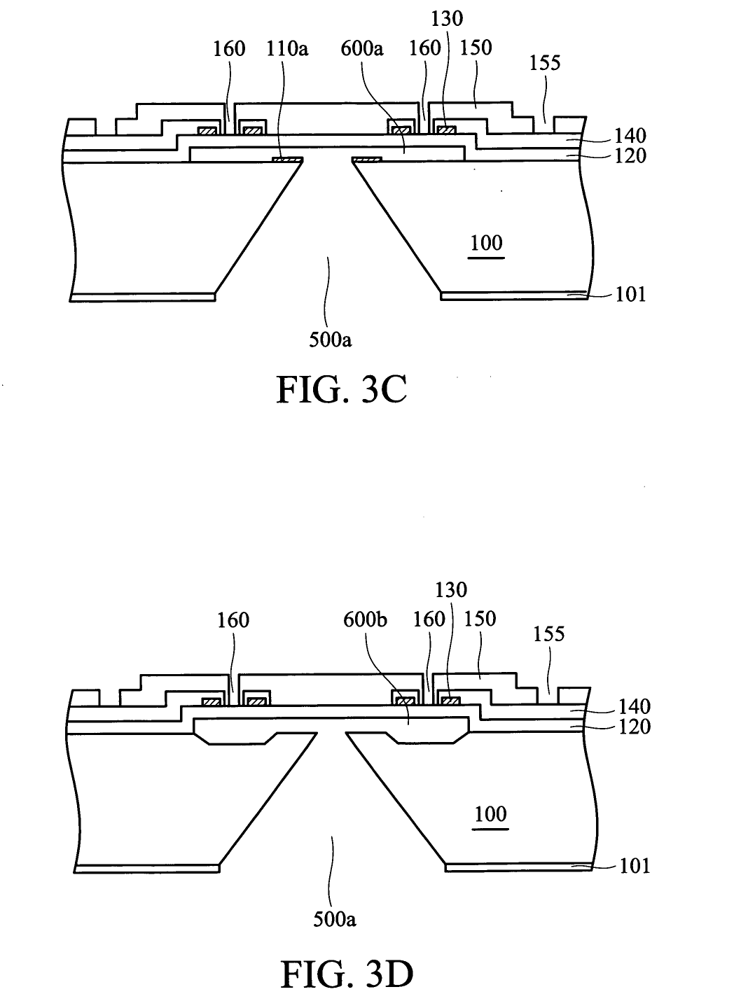

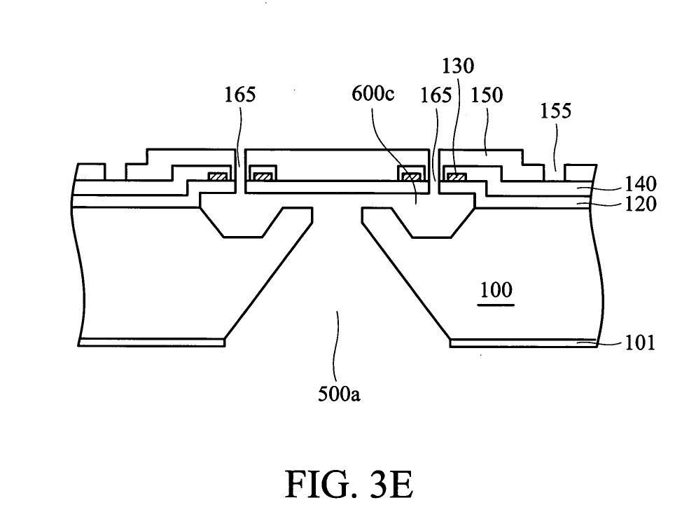

FIGS. 3A-3E are schematic views of a method for manufacturing a fluid injector in accordance with a first embodiment of the present invention using multiple sacrificial layers with different etching rates to create a chamber neck between an enlarged fluid chamber and a fluid channel. The chamber neck can stabilize ejection of the fluid droplet.

Referring to FIG. 3A, a substrate 100, such as a single crystal silicon wafer, having a first surface 1001 and a second surface 1002 is provided. A patterned first sacrificial layer 110a is formed on the first surface 1101 of the silicon substrate 100. A patterned second sacrificial layer 110b is then formed overlying the first surface 1101 of the silicon substrate 100 covering the first sacrificial layer 110a. The first sacrificial layer 110a is formed at both sides of the fluid channel with a thickness less than the second sacrificial layer 110b. The first sacrificial layer 110a comprises chemical vapor deposition of silicon nitride with a thickness of approximately 1000 Å. The second sacrificial layer 110b comprises chemical vapor deposition of borophosphosilicate glass (BPSG), phosphosilicate glass (PSG), or other silicon oxide material with a thickness between approximately 6500-11000 Å.

Sequentially, a patterned structural layer 120 is conformally formed on the first surface 1001 of the substrate 100 covering the patterned second sacrificial layer 110b. The structural layer 120 is a low stress silicon oxynitride (SiON) or low stress silicon nitride (Si₃N₄). The stress of the silicon oxynitride (SiON) is approximately 50 to 300 MPa. The low stress silicon oxynitride (SiON) is deposited by chemical vapor deposition (CVD). A low stress silicon oxynitride (SiON) 101 is simultaneously formed on the second surface 1002 of the silicon substrate 100.

A fluid actuator 130, a signal transmitting circuit 140 communicating with the fluid actuator 130 and a passivation layer 150 covering the fluid actuator 130 and the signal transmitting circuit 140 are formed on the structural layer 120. The fluid actuator 130 comprises a thermal bubble actuator. The thermal bubble actuator comprises a patterned resist layer 130. The patterned resist layer 130 is formed on the structural layer 120 to serve as a heater. The resist layer 130 comprises HfB₂, TaAl, TaN, or TiN. The resist layer 130 can be deposited using PVD, such as evaporation, sputtering, or reactive sputtering.

Sequentially, a patterned conductive layer 140, such as Al, Cu, or Al—Cu alloy, is formed on the structural layer 120 communicating with the resist layer 130 to act as a signal transmitting circuit 140. The conductive layer 140 may be deposited using PVD, such as evaporation, sputtering, or reactive sputtering. A passivation layer 150 is formed on the substrate 100 covering the structural layer 120 and the signal transmitting circuit 140. The passivation layer 150 comprises an opening 155 exposing the contact pad of the signal transmitting circuit (not shown).

Referring to FIG. 3B, an opening 105 is defined in the low stress silicon oxynitride (SiON) layer 101 exposing the second face 1002 of the single crystal silicon substrate 100. While forming the fluid channel, the opening 105 serves as a hard mask during etching of the single crystal silicon substrate 100. Next, the second surface 1002 of the silicon substrate 100 is etched by wet etching to form a fluid channel 500a. The fluid channel 500a exposes the second sacrificial layer 110b. Preferably, wet etching is performed using KOH, tetramethyl ammonium hydroxide (TMAH), or ethylene diamine pyrochatechol (EDP) solution.

Referring to FIG. 3C, the second sacrificial layer 110b is etched and removed by wet etching to form a first fluid chamber 600a. Wet etching is performed using HF solution. It should be noted that the use of wet etching solution requires high etching selectivity between the first sacrificial layer 110a and the second sacrificial layer 110b.

Referring to FIG. 3D, the exposed surface of the single crystal silicon substrate 110 is etched and the first chamber 600a is enlarged by wet etching. An enlarged first chamber 600b is thus formed. Preferably, wet etching is performed using KOH, tetramethyl ammonium hydroxide (TMAH), or ethylene diamine pyrochatechol (EDP) solution.

Referring to FIG. 3E, the first sacrificial layer 110a is removed by wet etching to form an enlarged fluid chamber 600c. The first sacrificial layer 110a is etched using condensed HF solution. The etching rate of the silicon nitrate is approximately 75 Å/min. Subsequently, the enlarged fluid chamber 600c is thus formed by wet etching. Preferably, wet etching is performed using KOH, tetramethyl ammonium hydroxide (TMAH), or ethylene diamine pyrochatechol (EDP) solution.

A nozzle 165 is formed by etching the structural layer 120 along the opening 160. The nozzle 160 communicates with the fluid chamber for ejecting micro fluid from the nozzle 160. The nozzle 160 is preferably formed by plasma etching, chemical dry etching, or reactive ion etching (RIE). A monolithic fluid injector is thus obtained using multiple sacrificial layers.

Accordingly, the monolithic fluid injector is formed comprising a chamber neck between a fluid chamber and a fluid channel. The chamber neck can stabilize ejection of the fluid droplet. When activating the thermal bobble generators, ink is pressurized and the fluid droplet is ejected. The force generated by ejection is contained by the fluid chamber, thus preventing the perturbation of neighboring fluid chambers.

Second Embodiment

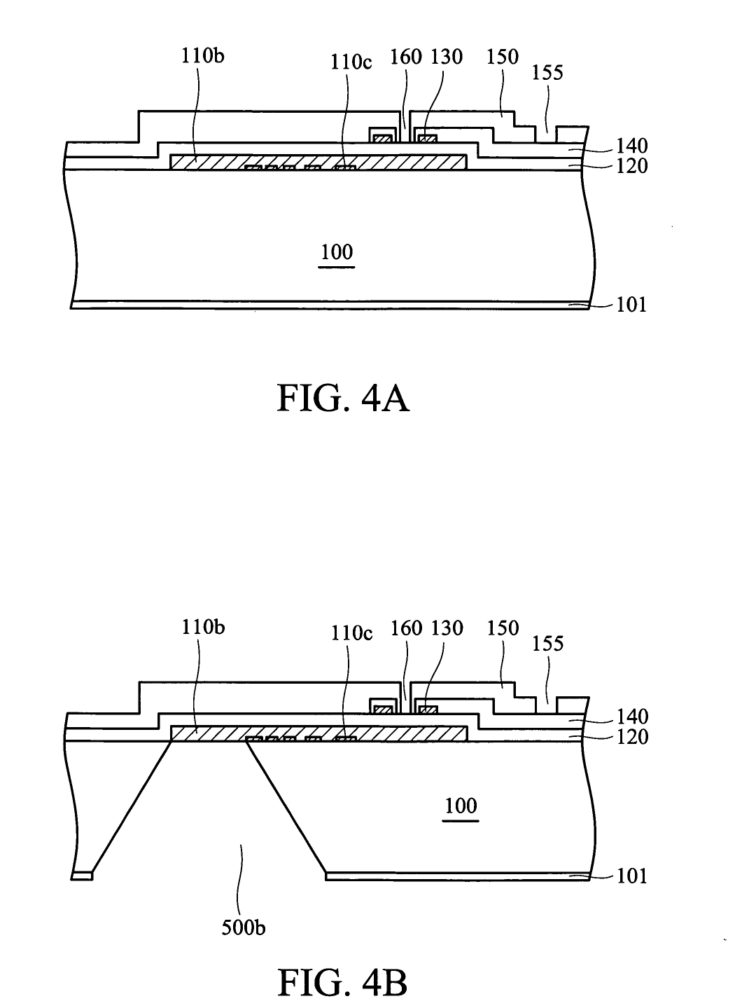

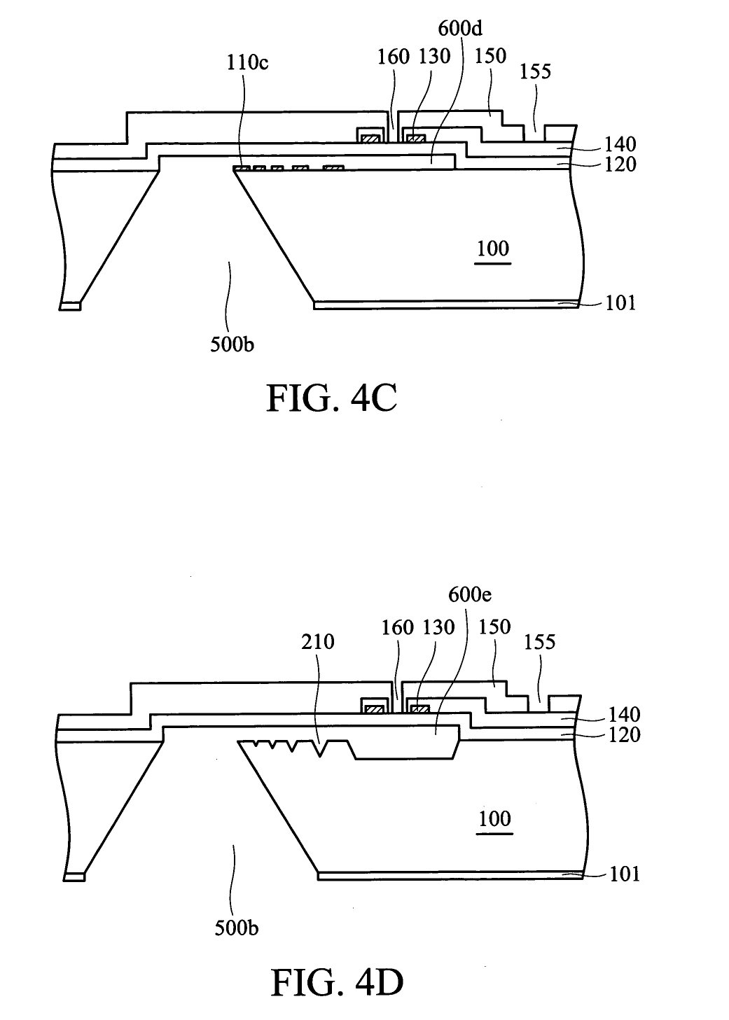

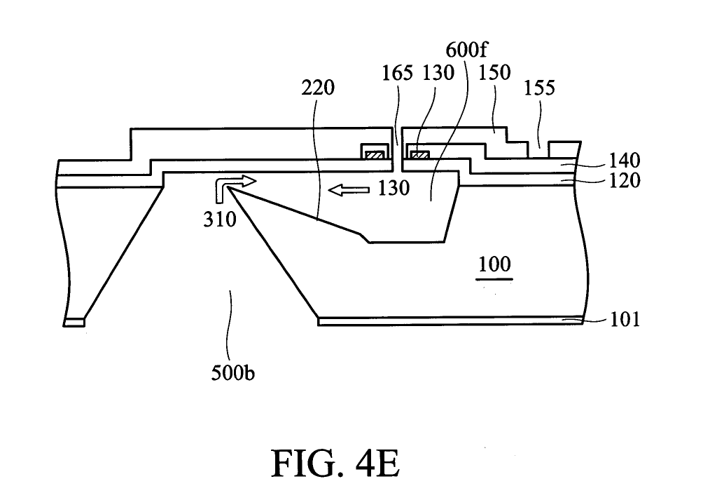

FIGS. 4A-4E are schematic views of a method for manufacturing a fluid injector in accordance with a second embodiment of the present invention using multiple sacrificial layers with different etching rates to create a slant adjacent to the fluid channel to impede backfill of the fluid and prevent perturbation in neighboring chambers, thereby stabilizing ejection of the fluid droplet.

Referring to FIG. 4A, a substrate 100, such as a single crystal silicon wafer, having a first surface 1001 and a second surface 1002 is provided. A patterned first sacrificial layer 110a is formed on the first surface 1101 of the silicon substrate 100. The first sacrificial layer 110c is formed at one side of the fluid channel and patterned into a plurality of areas with increasing width and gaps. A patterned second sacrificial layer 110b is then formed overlying the first surface 1101 of the silicon substrate 100 covering the first sacrificial layer 110c. The thickness of the first sacrificial layer 110c is less than that of the second sacrificial layer 110b. The first sacrificial layer 110c comprises chemical vapor deposition of silicon nitride with a thickness of approximately 1000 Å. The second sacrificial layer 110b comprises chemical vapor deposition of borophosphosilicate glass (BPSG), phosphosilicate glass (PSG), or other silicon oxide material with a thickness between approximately 6500-11000 Å.

Sequentially, a patterned structural layer 120 is conformally formed on the first surface 1001 of the substrate 100 covering the patterned second sacrificial layer 110b. The structural layer 120 is a low stress silicon oxynitride (SiON) or low stress silicon nitride (Si₃N₄). The stress of the silicon oxynitride (SiON) is approximately 50 to 300 MPa. The low stress silicon oxynitride (SiON) is deposited by chemical vapor deposition (CVD). A low stress silicon oxynitride (SiON) 101 is simultaneously formed on the second surface 1002 of the silicon substrate 100.

A fluid actuator 130, a signal transmitting circuit 140 communicating with the fluid actuator 130 and a passivation layer 150 covering the fluid actuator 130 and the signal transmitting circuit 140 are formed on the structural layer 120. The formation process is nearly identical to that of the first embodiment and for the sake of simplicity its detailed description is omitted herein.

Referring to FIG. 4B, an opening 105 is defined in the low stress silicon oxynitride (SiON) layer 101 exposing the second face 1002 of the single crystal silicon substrate 100. While forming the fluid channel, the opening 105 serves as a hard mask during etching of the single crystal silicon substrate 100. Next, the second surface 1002 of the silicon substrate 100 is etched by wet etching to form a fluid channel 500b. The fluid channel 500b exposes the second sacrificial layer 110b. Preferably, wet etching is performed using KOH, tetramethyl ammonium hydroxide (TMAH), or ethylene diamine pyrochatechol (EDP) solution.

Referring to FIG. 4C, the second sacrificial layer 110b is etched and removed by wet etching to form a first fluid chamber 600d. Wet etching is preferably performed using HF solution. It should be noted that the wet etching solution used requires high etching selectivity between the first sacrificial layer 110c and the second sacrificial layer 110b.

Referring to FIG. 4D, the exposed surface of the single crystal silicon substrate 110 is etched and the first chamber 600d is enlarged by wet etching. Gaps between the first sacrificial areas are etched forming V-shaped grooves 210 with increasing depths. Preferably, wet etching is performed using KOH, tetramethyl ammonium hydroxide (TMAH), or ethylene diamine pyrochatechol (EDP) solution.

Referring to FIG. 4E, the first sacrificial layer 110c is removed by wet etching to form an enlarged fluid chamber 600f. The V-shaped grooves 210 are further etched and transformed into a slant 220. The first sacrificial layer 110c is etched using condensed HF solution. The etching rate of silicon nitrate is approximately 75 Å/min. Subsequently, the enlarged fluid chamber 600f is thus formed by wet etching. Preferably, wet etching is performed using KOH, tetramethyl ammonium hydroxide (TMAH), or ethylene diamine pyrochatechol (EDP) solution.

A nozzle 165 is formed by etching the structural layer 120 along the opening 160. The nozzle 160 communicates with the fluid chamber for ejecting micro fluid from the nozzle 160. The nozzle 160 is preferably formed by plasma etching, chemical dry etching, or reactive ion etching (RIE). A monolithic fluid injector is thus obtained using multiple sacrificial layers.

Accordingly, the monolithic fluid injector is formed comprising a slant 220 in an enlarged fluid chamber 600f. The slant 220 facilitates refilling (as shown by the arrow 130) and impedes backfill (as shown by the arrow 310) of fluid in the chamber. When activating the thermal bubble generators, ink is pressurized and the fluid droplet is ejected. The force generated is contained by the fluid chamber preventing the perturbation of neighboring fluid chambers, thus stabilizing ejection of the fluid droplet.

Third Embodiment

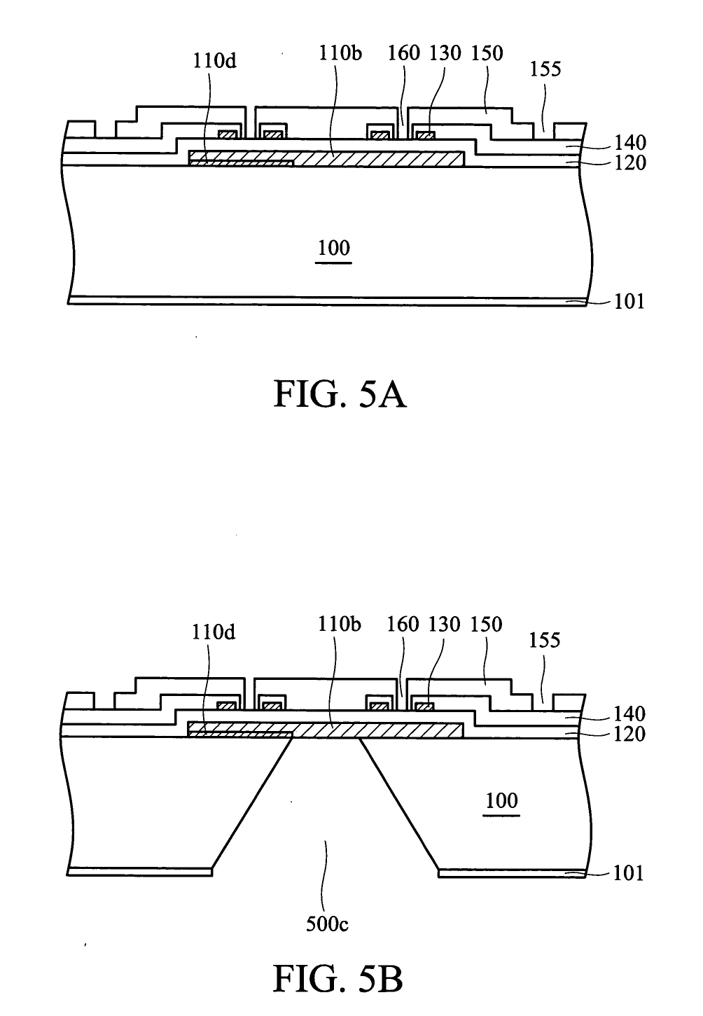

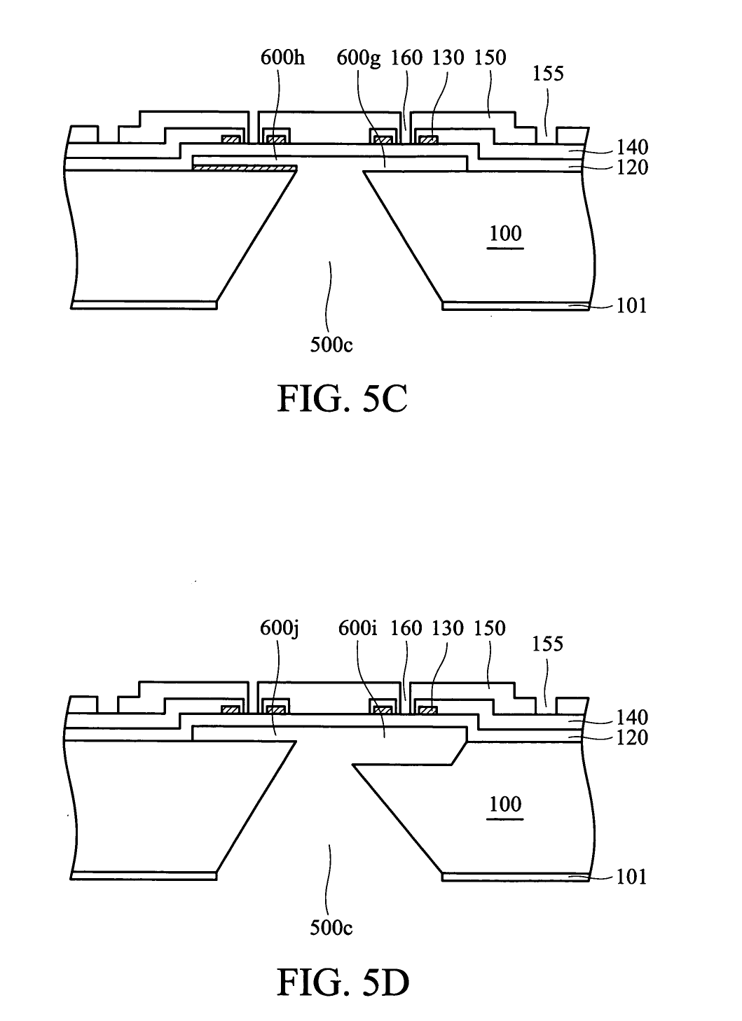

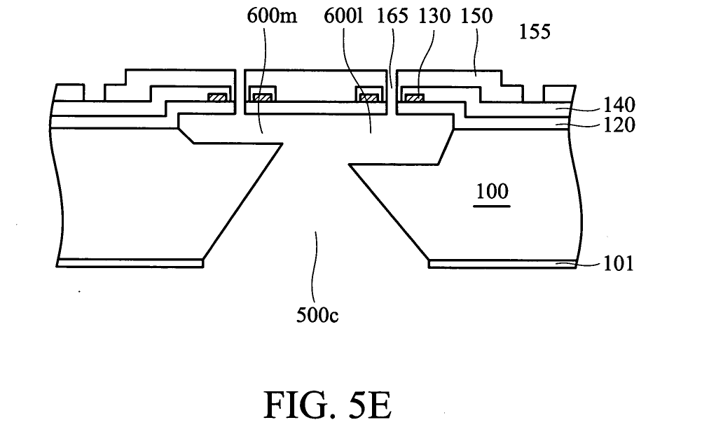

FIGS. 5A-5E are schematic views of a method for manufacturing a fluid injector in accordance with a third embodiment of the present invention using multiple sacrificial layers with different etching rates to create a single print-head chip with different chamber sizes, thereby ejecting droplets with different sizes and improving printing resolution.

Referring to FIG. 5A, a substrate 100, such as a single crystal silicon wafer, having a first surface 1001 and a second surface 1002 is provided. A patterned first sacrificial layer 110d is formed on the first surface 1101 of the silicon substrate 100. A patterned second sacrificial layer 110b is then formed overlying the first surface 1101 of the silicon substrate 100 covering the first sacrificial layer 110d. The first sacrificial layer 110d is formed at one side of the fluid channel with a thickness less than the second sacrificial layer 110b. The first sacrificial layer 110d comprises chemical vapor deposition of silicon nitride with a thickness of approximately 100 Å. The second sacrificial layer 110b comprises chemical vapor deposition of borophosphosilicate glass (BPSG), phosphosilicate glass (PSG), or other silicon oxide material with a thickness between approximately 6500-11000 Å.

Sequentially, a patterned structural layer 120 is conformally formed on the first surface 1001 of the substrate 100 covering the patterned second sacrificial layer 110b. The structural layer 120 is a low stress silicon oxynitride (SiON) or low stress silicon nitride (Si₃N₄). The stress of the silicon oxynitride (SiON) is approximately 50 to 300 MPa. The low stress silicon oxynitride (SiON) is deposited by chemical vapor deposition (CVD). A low stress silicon oxynitride (SiON) 101 is simultaneously formed on the second surface 1002 of the silicon substrate 100.

A fluid actuator 130, a signal transmitting circuit 140 communicating with the fluid actuator 130 and a passivation layer 150 covering the fluid actuator 130 and the signal transmitting circuit 140 are formed on the structural layer 120. The formation process is nearly identical to that of the first embodiment and for the sake of simplicity its detailed description is omitted herein.

Referring to FIG. 5B, an opening 105 is defined in the low stress silicon oxynitride (SiON) layer 101 exposing the second face 1002 of the single crystal silicon substrate 100. While forming the fluid channel, the opening 105 serves as a hard mask during etching of the single crystal silicon substrate 100. Next, the second surface of the silicon substrate is etched by wet etching to form a fluid channel 500c. The fluid channel 500c exposes the second sacrificial layer 110b. Preferably, wet etching is performed using KOH, tetramethyl ammonium hydroxide (TMAH), or ethylene diamine pyrochatechol (EDP) solution.

Referring to FIG. 5C, the second sacrificial layer 110b is etched and removed by wet etching to form a first fluid chamber 600g and a second fluid chamber 600h, wherein the first fluid chamber 600g expose the substrate and the second fluid chamber 600h expose the first sacrificial layer 100d. Wet etching is performed using HF solution. It should be noted that the wet etching solution used requires high etching selectivity between the first sacrificial layer 110d and the second sacrificial layer 110b.

Referring to FIG. 5D, the exposed surface of the substrate 110 is etched and the first chamber 600g is enlarged by wet etching. An enlarged first chamber 600i larger than the second fluid chamber 600j is thus formed. Preferably, wet etching is performed using KOH, tetramethyl ammonium hydroxide (TMAH), or ethylene diamine pyrochatechol (EDP) solution. The first sacrificial layer 110d is then removed by wet etching to form an enlarged second fluid chamber 600j. The first sacrificial layer 110d is etched using condensed HF solution. The etching rate of the silicon nitrate is approximately 75 Å/min.

Referring to FIG. 5E, the enlarged first fluid chamber 600l and second fluid chamber 600m are thus formed by further wet etching. Preferably, wet etching is performed using KOH, tetramethyl ammonium hydroxide (TMAH), or ethylene diamine pyrochatechol (EDP) solution.

A nozzle 165 is formed by etching the structural layer 120 along the opening 160. The nozzle 160 communicates with the fluid chamber for ejecting micro fluid from the nozzle 160. The nozzle 160 is preferably formed by plasma etching, chemical dry etching, or reactive ion etching (RIE). A monolithic fluid injector is thus obtained using multiple sacrificial layers.

Accordingly, the monolithic fluid injector comprising different chamber sizes is formed, thereby ejecting droplets with different sizes. The single print-head chip with different chamber sizes can also improve printing resolution.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

1. A method for fabricating an enlarged fluid chamber, comprising:
providing a substrate;
forming a patterned first sacrificial layer on the substrate;
forming a patterned second sacrificial layer overlying the substrate and covering the first sacrificial layer, wherein the first sacrificial layer and the second layer are made of different materials;
forming a patterned structural layer overlying the substrate covering the patterned second sacrificial layer;
forming a fluid channel through the substrate and exposing the second sacrificial layer;
removing the second sacrificial layer to form a chamber; and
enlarging the chamber.

2. The method as claimed in claim 1, wherein the patterned first sacrificial layer is located on the two sides of the fluid channel.

3. The method as claimed in claim 2, further comprising removing the patterned first sacrificial layer to create a neck connecting the enlarged chamber and the fluid channel.

4. The method as claimed in claim 1, wherein the patterned first sacrificial layer comprises a plurality of gaps with increasing distances at one of the two sides of the fluid channel.

5. The method as claimed in claim 4, further comprising:
enlarging the chamber and forming a plurality of V-shaped grooves between the patterned first sacrificial layer, thereby increasing the dimensions of the V-shaped grooves;
removing the patterned first sacrificial layer; and
enlarging the chamber and V-shaped grooves to create a slant neck connecting the chamber and the fluid channel.

6. The method as claimed in claim 1, wherein the patterned first sacrificial layer is located at one of the two sides of the fluid channel.

7. The method as claimed in claim 6, further comprising;
removing the first sacrificial layer; and
enlarging the chamber, thereby creating a first chamber and a second chamber on each side of the fluid channel, and the size of the first chamber exceeds the second chamber.

8. The method as claimed in claim 1, further comprising:
forming an actuator on the structural layer;
forming a driving circuit communicating with the actuctor; and
a passivation layer covering the actuator and the driving circuit.

9. The method as claimed in claim 1, wherein the first sacrificial layer comprises silicon nitride.

10. The method as claimed in claim 1, wherein the second sacrificial layer comprises borophosphosilicate glass (BPSG), phosphosilicate glass (PSG), or silicon oxide.

11. The method as claimed in claim 1, wherein the structural layer comprises silicon oxynitride or low stress silicon nitride.

12. The method as claimed in claim 1, wherein the step of forming a fluid channel is achieved by wet etching.

13. The method as claimed in claim 12, wherein wet etching is performed using KOH, tetramethyl ammonium hydroxide (TMAH), or ethylene diamine pyrochatechol (EDP) solution.

14. The method as claimed in claim 1, wherein the step of removing the second sacrificial layer is achieved by wet etching.

15. The method as claimed in claim 14, wherein wet etching is performed using HF solution.

16. The method as claimed in claim 3, wherein the step of removing the first sacrificial layer is achieved by wet etching.

17. The method as claimed in claim 16, wherein wet etching is performed using concentrated HF solution.

18. The method as claimed in claim 1, further comprising forming a nozzle by etching the structural layer, thereby communicating with the fluid chamber.
